(19) United States
(12) Patent Application Publication
(10) Pub. No.: US 2023/0175643 A1
(43) Pub. Date: Jun. 8, 2023

(54) PORTABLE MEETINGS PRESENTATION AND RECORDER SYSTEM

(71) Applicant: BT5 Technologies, LLC, Katy, TX (US)

(72) Inventor: Luis Bustamante, The Woodlands, TX (US)

(21) Appl. No.: 17/927,688

(22) PCT Filed: Jun. 7, 2021
(86) PCT No.: PCT/US21/36263

§ 371 Date: Nov. 23, 2022

Related U.S. Application Data
(60) Provisional application No. 63/036,417, filed on Jun. 8, 2020.
(60) Provisional application No. 63/197,482, filed on Jun. 6, 2021.

(51) Int. Cl. F16M 11/38; F16B 7/14; F16M 11/08; F16M 11/18; F16M 11/04; F16M 11/26; G03B 17/56; G03B 31/00; G06F 3/14

(52) U.S. Cl. CPC F16M 11/38; F16B 7/14; F16M 11/08; F16M 11/18; F16M 11/041; F16M 11/26; G03B 17/561; G03B 31/00; G06F 3/1423; F16M 2200/08; F16M 2200/068

(57) ABSTRACT

There is provided a portable system which includes a central cylindrical control module having a central axis and a lower body portion. The cylindrical control module has at least one telescopic arm which is contained within the cylindrical control module in a first locked position in the lower body portion and in a second unlocked position the telescopic arm is capable of extending and rotating vertically and horizontally to a selected location. The telescopic arm receiving a periphery device in a receiving slot at an end of the telescopic arm which electronically connects with said central control module.

### CROSS REFERENCE TO RELATED APPLICATIONS

This application claims the benefit of and priority to U.S. Provisional Patent Application No. 63/036,417 filed on Jun. 8, 2020 which is incorporated by reference herein in its entirety.

### FIELD OF THE INVENTION

The present invention relates generally to a technological portable hub system for presentations and teamwork enhancement system. More particularly, the present invention relates to a portable system to hub with multi-functional capabilities for power, data and video transmission, with multi-portable monitors, video-cameras, microphone, speakers, memory, power bank, wireless and wired connectivity, USB ports and mechanical slots to connect other apparatuses in a unique and portable piece of technology.

### BACKGROUND

The technological systems for presentations have been used for years. There is a need of a system that provide the users with the flexibility for transportation, to do 360 degrees presentations in a compact and plug-and-play design with ease to use especially when traveling.

### SUMMARY OF THE INVENTION

Many people find it difficult to teamwork or work with third parties remotely as they do not have all the necessary equipment to do presentations, video-chats and record the meetings outside of an equipped meeting room. This include cases of exhibitors at a trade show where they don't have access to a room or at a table with no monitor and share a presentation, or when a student in the room or classroom and have no way to access a TV or monitor to share and collaborate on content, or when employees at the office cannot to attend a presentation because the meeting rooms are fully booked, etc.

The present invention provides a portable system that helps to perform group presentations, videoconferencing, video recording and allows the use of other peripheral services to enhance work productivity and entertainment, comfortable usage of computer peripherals and portability.

The present invention provides the user with a new option of connectivity and capabilities for enhancing the teamwork performance and entertainment in any place and especially when traveling.

This invention includes different features such as telescopic arms that can rotate vertically and horizontally to install either one, two, three or up to four touch-monitor monitors, one, two, or up to three video-cameras for different angles of video-recording, a built-in monitor to show what the cameras are pointing at, microphone, speakers, internal memory, power bank, wireless and wired connectivity capabilities, voice activation, USB ports, ethernet port and wi-fi access-point, among others.

The retractile and telescopic design of this invention permits also to provide power and interchange data with other devices such as a computer, smartphones, and tablets.

Some users that would use this invention to solve some of their problems and/or inconveniences to video chat, videorecord and teamwork, are: 1) People who use or interact with computers and computer peripheral devices; 2) Professionals who work on a computer on a daily basis, that need to work remotely and find difficulties at multitasking or quickly setting up computer peripherals; 3) Students who need to carry out various tasks at the same time, while doing homework or receiving an online lesson; 4) Companies whose employees have regular videoconference or presentation meetings and have limited meeting rooms in the office building; 5) Gamers that play computer games and that are constantly on the move; 6) Families or group of friends who like to video-record and share special moments, such as parties in the kitchen, barbecues in the pool area, and do not have access to a 360 degrees video camera with speakers and microphone.

The usage of this invention will be explained later in the respective detailed description section of this document.

The present invention is a portable tower hub system which comprises a central cylindrical control module having a central axis and a lower body portion. The cylindrical control module has at least one telescopic arm which is contained within the central cylindrical control module in a first locked position in the lower body portion and in a second unlocked position, with the telescopic arm capable of extending and rotating vertically and horizontally to a selected location. The telescopic arm is capable of receiving a periphery device in a receiving slot at an end of the telescopic arm to electrically connect the periphery device to the central cylindrical control module.

In an embodiment, the portable system of the present invention includes a monitor base connected at the end of the at least one telescopic arm. In an embodiment, the portable system of the present invention includes where the monitor base has a locking pin for locking the at least one telescopic arm in the first locked position.

In an embodiment, the portable system of the present invention includes where the central control module is extendable in a telescopic manner along the central axis. With the portable system of the present invention, the central control module includes multimedia peripherals, which can be raised from a first position to a second position by extending the telescopic central control module.

In an embodiment, the portable system of the present invention includes where the monitor base rotates 15 degrees laterally from a center line of the at least one telescopic arm to allow articulation between the at least one telescopic arm and the monitor base. The portable system of the present invention includes embodiments where the at least one telescopic arm includes two, three or up to four telescopic arms.

In an embodiment, the portable system of the present invention includes the monitor base receiving a cable from the at least one telescopic arm and the cable connects to a port located on the lower body portion of the central cylindrical control module. Further, with the portable system of the present invention, the monitor base has an opening mechanism which moves from an engaged position to a disengaged position. This mechanism allows the movement of the at least one telescopic arm from a first locked position to a second unlocked position.

### BRIEF DESCRIPTION OF DRAWINGS

FIG. 1 is an illustration of the isometric front view of this invention with the arms in folded position.

FIG. 2 is an illustration of the front view of this invention, showing how to move the telescopic control module.

FIG. 3 is an illustration of the arm locking system of this invention.

FIG. 4 is an illustration of a sectional view of the arm locking system of this invention.

FIGS. 5A, 5B, and 5C are illustrations of how to deploy the arms and the control module of this invention.

FIG. 6 is an isometric illustration of this invention with the four arms and control module deployed.

FIG. 7 is a front view of this invention with the four arms and control module deployed.

FIG. 8 is an illustration of the multimedia peripherals located in the top side of the control module of this invention.

FIG. 9 is an illustration of the control buttons located in the control module of this invention.

FIG. 10 is an illustration of the top view of this invention in deployed position.

FIG. 11 is an illustration of the monitor base with a side section view describing the internal monitor locking system.

FIGS. 12A, 12B, and 12C are an illustration of how the monitor's connector base can rotate horizontally.

FIG. 13 is an illustration of the isometric front view of the monitor and its control buttons.

FIG. 14 is an illustration of the isometric underneath rear view of the monitor and its USB port.

FIG. 15 is the illustration of the side view of this invention in a deployed position and showing how to install the monitors.

FIG. 16 illustrates the monitor's locking system when it is installed on the monitor base and the USB connection.

FIGS. 17A, 17B and 17C illustrate the invention in different configurations to fit two, three or up to four monitors.

FIG. 18 is an illustration of the connecting ports of this invention.

FIG. 19 is an illustration of different types of devices which can be connected at the same time to this invention.

FIG. 20 is an illustration of the general internal array of cables and PCBs of this invention.

FIG. 21 is an illustration of alternative options to provide power to this invention.

FIG. 22 is an illustration of the arms of the present invention in deployed positions and their movement angles.

FIG. 23 is an illustration of the invention in different types of work configurations.

FIG. 24 is an illustration of the invention in an exemplary array for personal use with the computer located in the side.

FIG. 25 is an illustration of the invention in an exemplary array for personal use with the computer located in the middle.

FIG. 26 is and illustration of an electronic block diagram option of the present invention.

### DETAILED DESCRIPTION

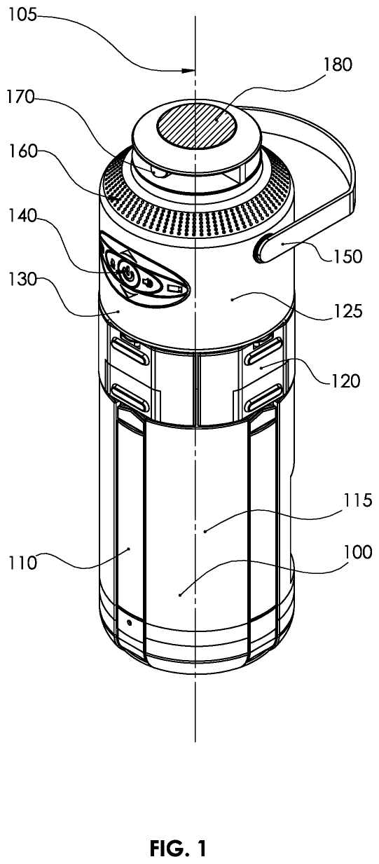

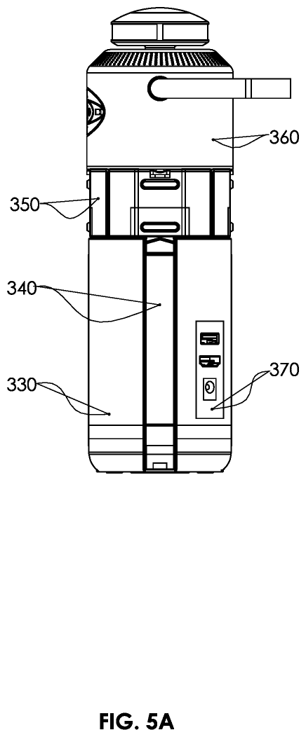

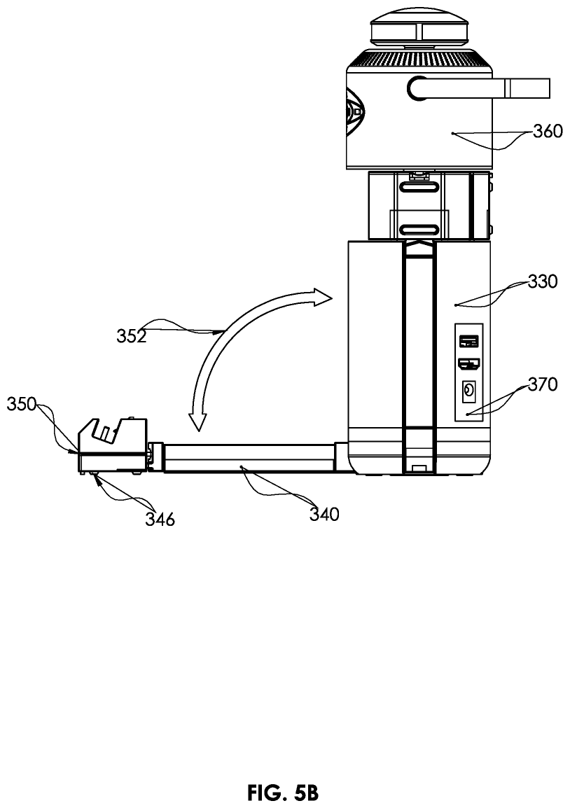

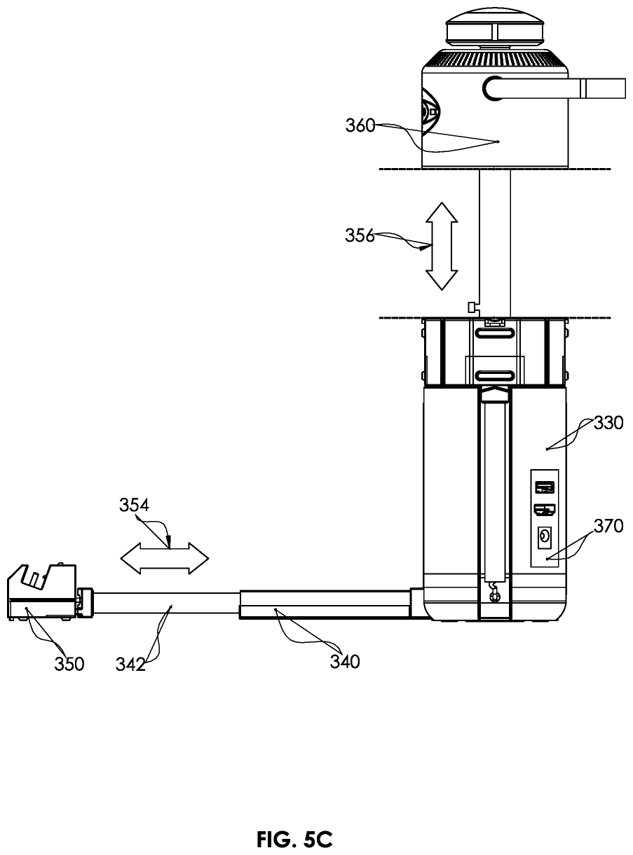

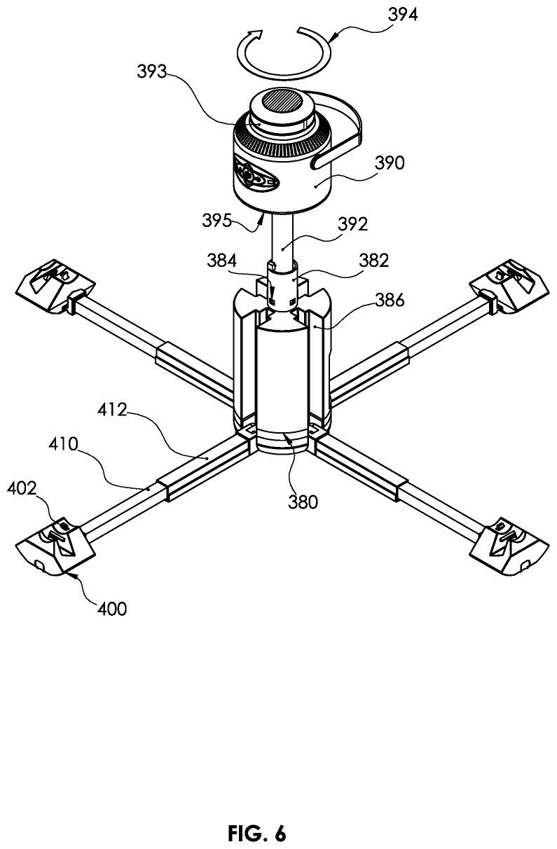

FIG. 1 shows an isometric view of the present invention including the lower body 100, the arms 110 in folding position are shown with the monitor bases 120, the control module 130 where the control buttons 140 are located, the foldable carrying holder 150 and the multimedia devices such as the speaker 160, camera 170 and microphone 180. The portable tower hub presentations and recorder system of the present invention includes a central cylindrical control module 130 having a central axis 105 and a lower body portion 100. The cylindrical control module has at least one telescopic arm 110 which is contained within the central cylindrical control module 130 in a first locked and folded up position in the lower body portion 100 and in a second unlocked position (as seen in FIGS. 5B, 5C and 6), with the telescopic arm 110 capable of extending and rotating vertically and horizontally to a selected location. The telescopic arm 110 is capable of receiving a periphery device in a receiving slot of the monitor bases 120 attached at an end of the telescopic arm 110 to electrically connect the periphery device to the central cylindrical control module 130. The monitor bases 120 are contained with and folded into the tower hub system when the telescopic arms 110 are folded up in the first locked position as in FIG. 1. In this manner, the monitor bases 120, telescopic arms 110 and outer surface wall sections 115 of the tower hub can combine to form a flat outer surface 125 on the cylinder hub when in the upward folded and locked position.

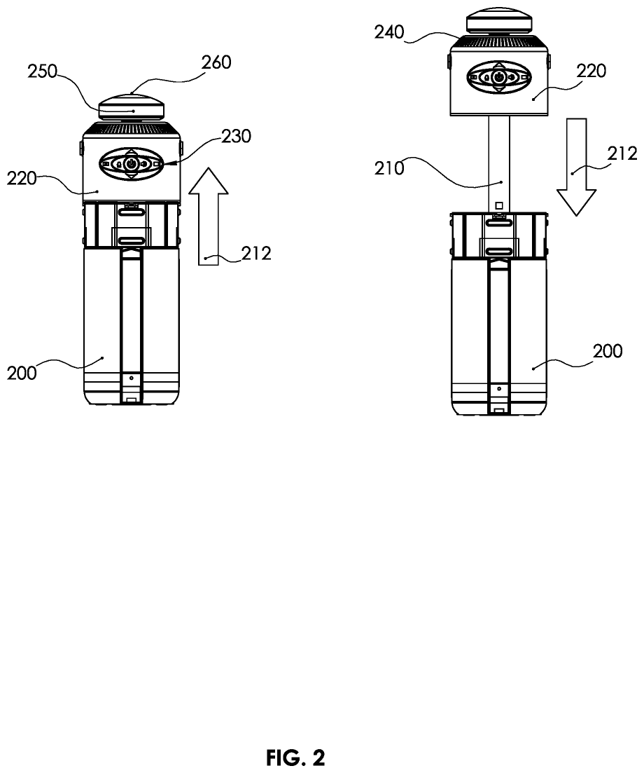

FIG. 2 shows the telescopic motion feature of the control module 220 along a vertical central axis 210 elevating the multimedia peripherals from the lower body 200 of this invention. The control module 220, where the control buttons 230, speaker 240, camera 250 and microphone 260 are located, can extend vertically approximately 75 mm 212 which raises the height of the camera 250 achieving a higher position over other apparatuses such as laptops. The control module is generally cylindrical in shape, but other shapes are within the scope of the present invention.

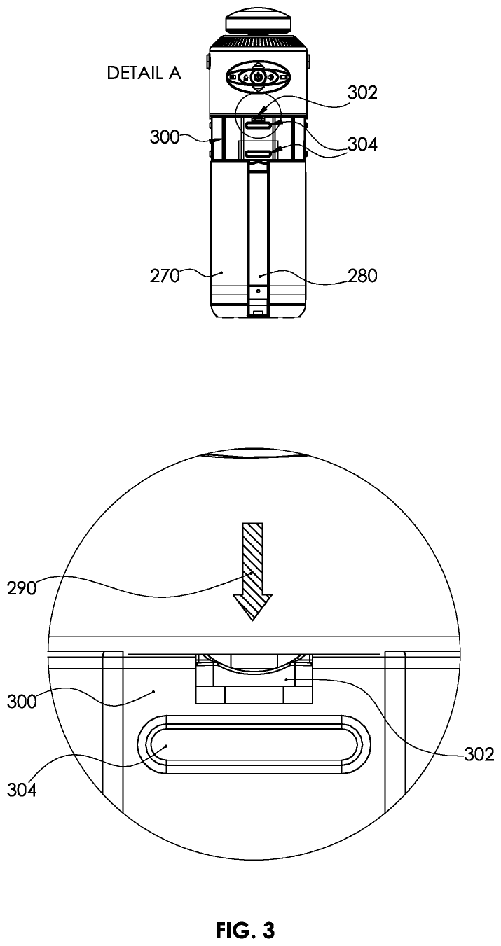

Referring to FIG. 3, there is shown the arm locking button 302 located in the monitor base 300. By pushing down 290 the arm locking button 302 the arm 280 can be released from the lower body 270. The grip pads 304 of the monitor base 300 provides fixation and stability to this invention.

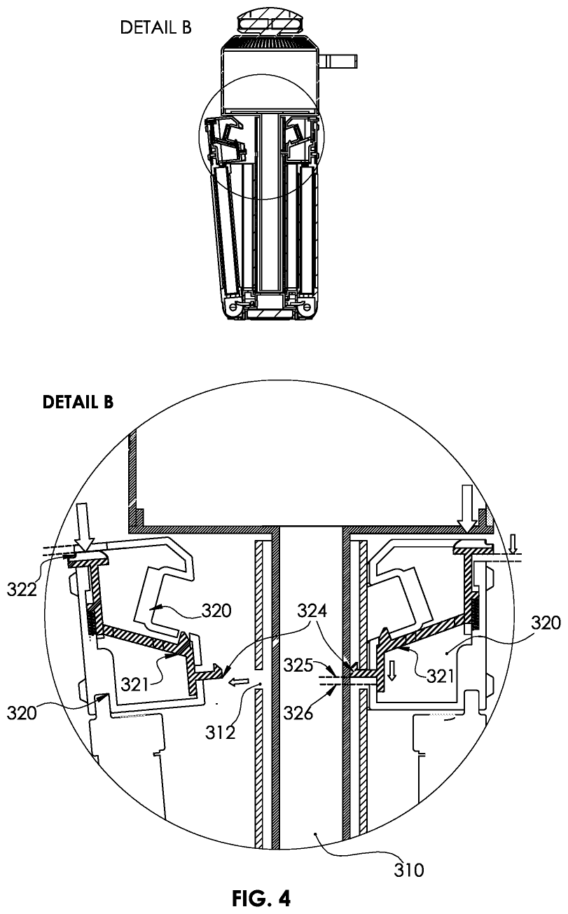

In FIG. 4, this DETAIL B figure shows how the arm locking mechanism 321 located in monitor base 320 can keep the arm closed and attached to the lower body 310 of this invention. When the arm release button 322 is pressed down, the pin 324 that locks in the slot 312 moves downward from locked position 325 to the open position 326, releasing the monitor base 320 from the lower body 310. By repeating this action in every arm locking mechanism, this will allow this invention to be deployed.

With FIGS. 5A, 5B, and 5C, these figures show the right-side view of the lower body 330 of this invention. In this view also shown are some of the connection ports 370. The control module 360 can be moved up in vertical extension sequence 356. The arm 340 includes its telescopic feature 342 and the monitor base 350. In FIG. 5B, when the monitor base 350 is unlocked from the lower body 330 of this invention, the arm 340 is opened to 90 degrees until a horizontal position. In FIG. 5C, the telescopic arm feature 342 can extend the monitor base 350 up to 4 inches in length 354 or more, thereby allowing to move the monitor away or closer to the users.

In FIG. 6, this figure shows the lower body 380 with the control module 390 fully extended along its axis by movement rod 392, the compartments 386 of the telescopic arms, the arms 412, the telescopic arms 410 with the monitor base 400 fully extended. In the monitor base 400, the securing pin 402 that enters in the slot 384 located in the central axis 382 of this invention is shown. The movement rod 392, which is connected to the control module 390 at a top end 395 of rod 392, extends in telescopic manner from inside the lower body 380 and the central axis 382. The control module 390 houses the video camera 393 which can rotate up to 360 degrees 394. Alternatively, the monitors can be installed on independent bases, not attached to the lower base, and be wired connected to the USB ports or via wireless to this invention. In this alternative configuration, the monitors and other apparatuses would be located farther from the main frame, if necessary.

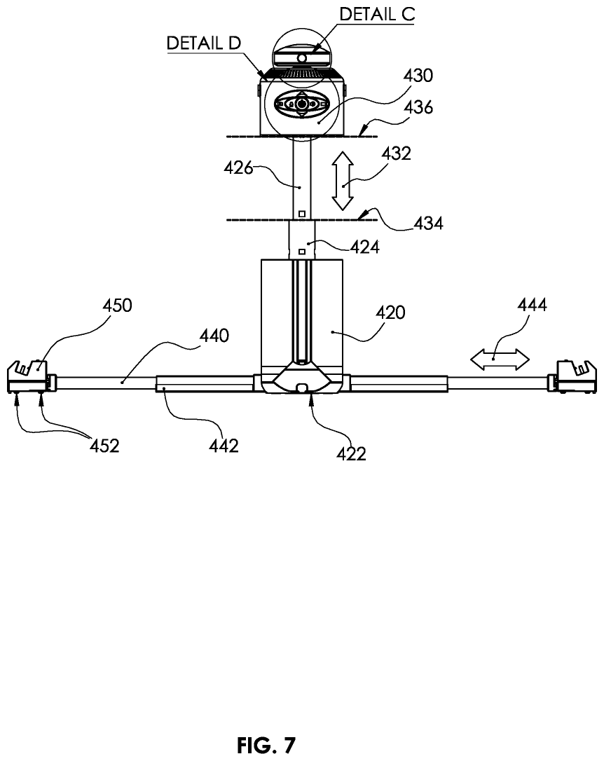

FIG. 7 is the figure of the front view of this invention in deployed position. This figure shows the lower body 420 and the control module 430 from its closed position 434 to its maximum height at open position 436, in total it extends about 75 mm in height 432 along its vertical axis 426 that slides along the guide 424. Folding arms 442, telescopic arms 440 extending from within folding arms 442, and the monitor base 450 are shown unfolded and extended for a length 444. The grip pads 452 are located on the support base of the monitor and on the lower body chassis 422 to provide stability to the invention.

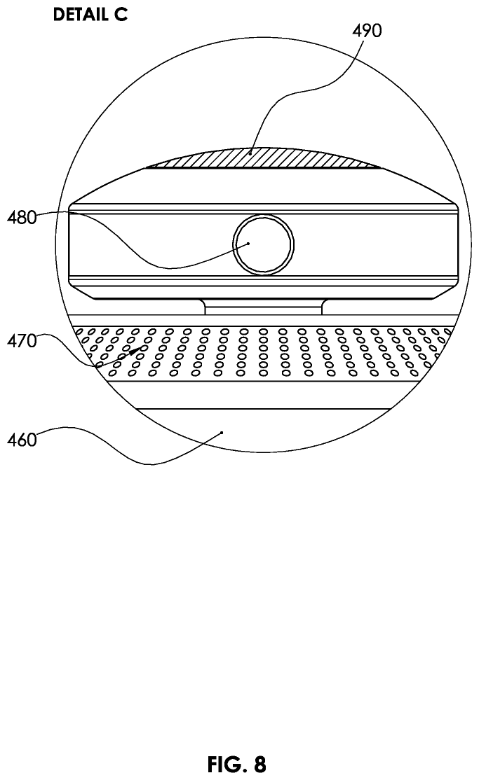

FIG. 8 is the DETAIL C figure that shows the multimedia features of this invention located in the upper side of the control module 460. The multimedia features include, but are not limited to, a microphone 490 located on the top of the module for the reception of voice or sound, a 360 degrees rotating video camera 480, and a speaker 470 for the emission of sound.

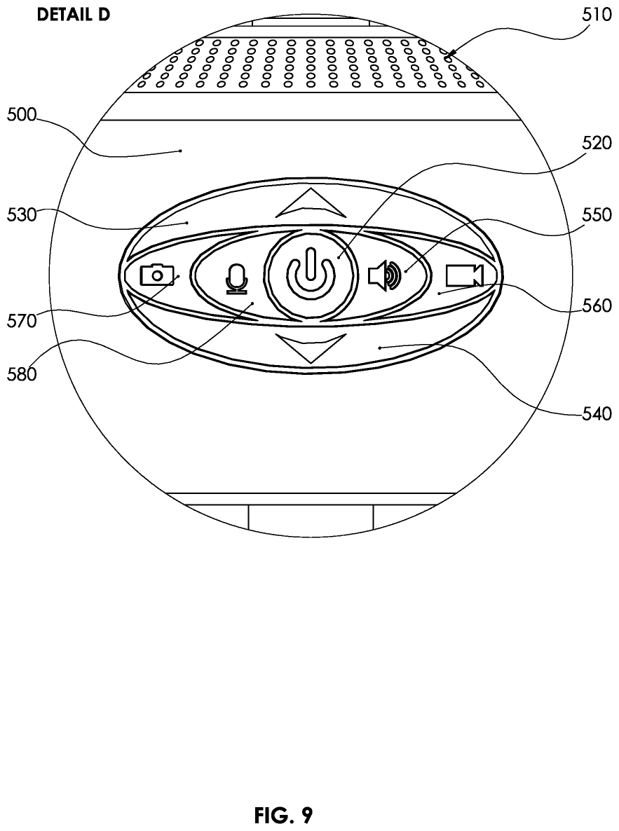

FIG. 9 is the DETAIL D figure where the control panel of this invention is shown. This section is located under speaker 510 in the control module 500 of this invention. The control panel includes at least the on/off button 520, the speaker activation button 550, the microphone button 580, a volume increase button 530, a volume decrease button 540, a button to activate and capture photos 570 and a button to activate and start the video camera 560. The buttons have a light indicator when they are activated. These features can be controlled directly from the control module of this invention, by voice activation, or from a wired or wireless connected apparatus such as a computer, tablet or phone.

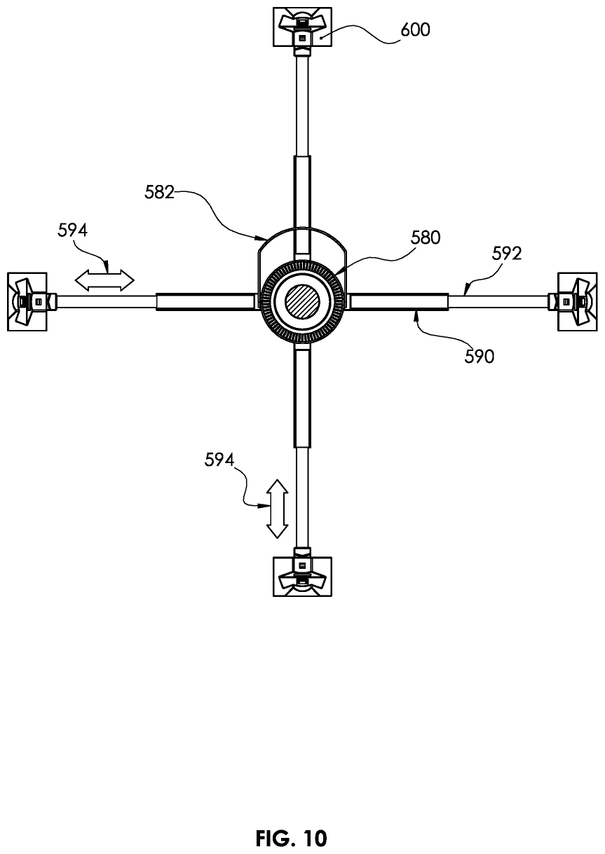

FIG. 10 shows the top view of this invention including the main body 580 with the 4 arms 590, the telescopic arms 592, the monitor bases 600, with the arms fully open and extended at length 594 and, the foldable carrying holder 582.

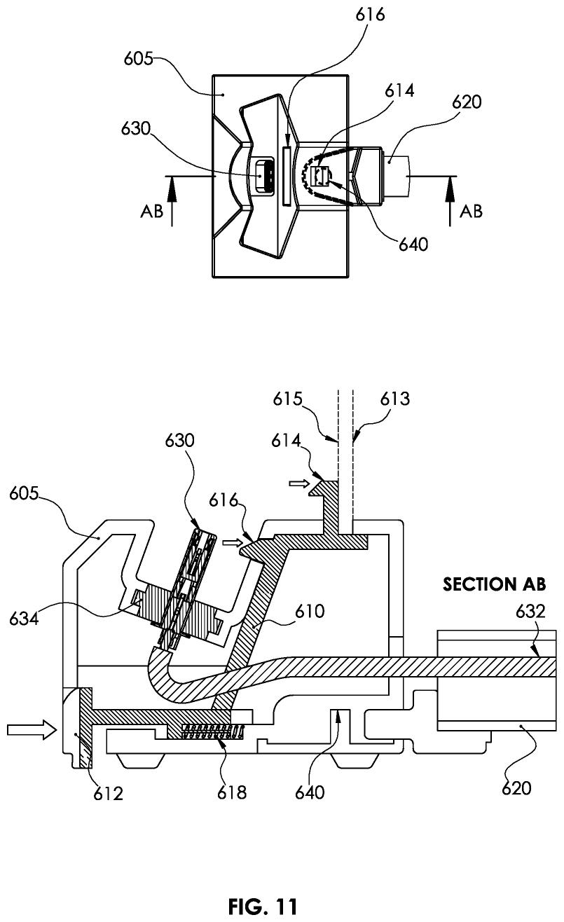

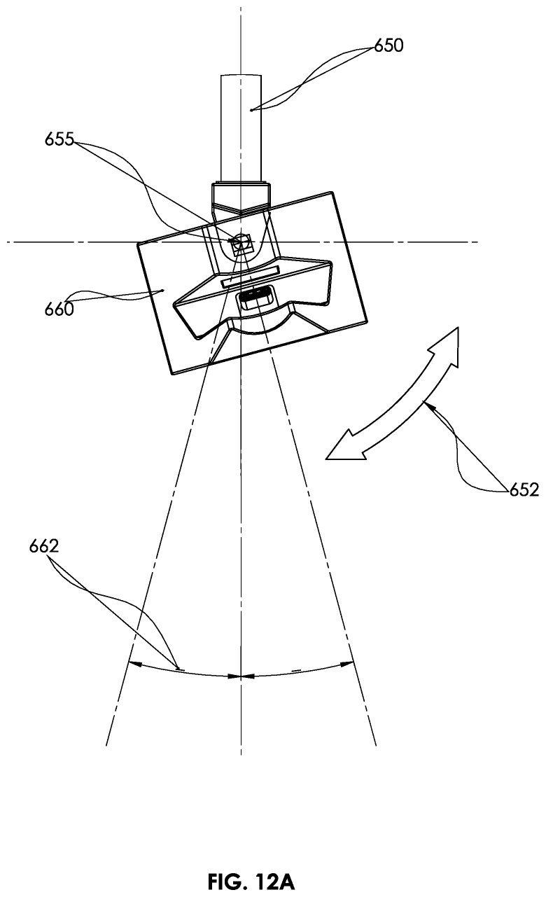

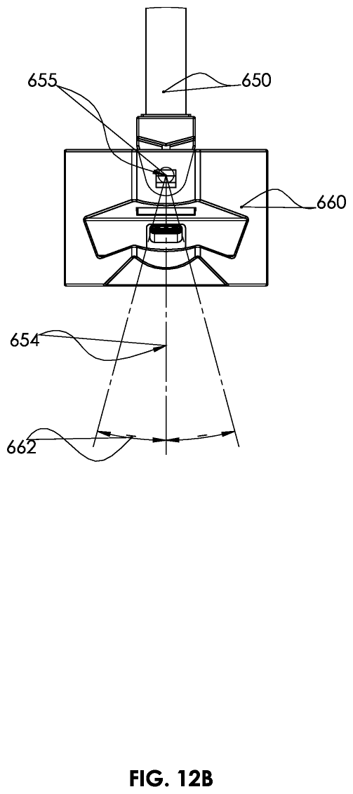

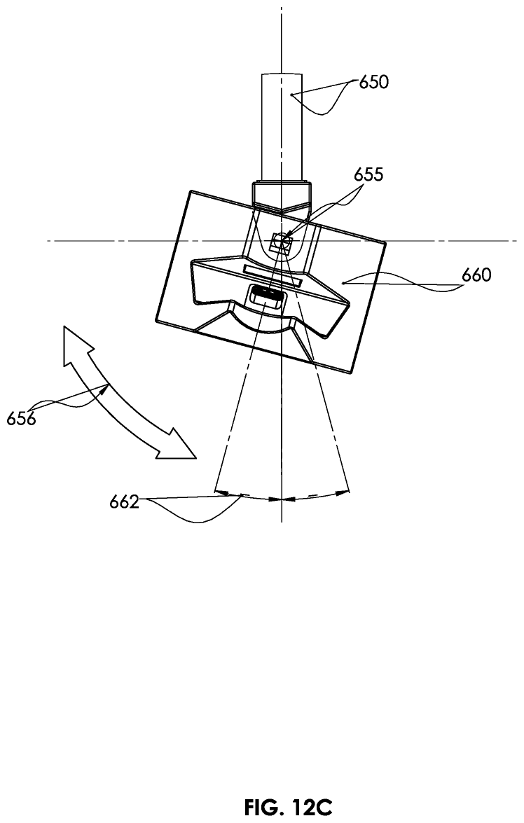

FIG. 11 shows the top view of the monitor base 605, which is attached to the telescopic arm 620 by means of a joint 640 that allows the monitor base 605 to rotate horizontally as will be explained in the next FIGS. 12A to 12C. The SECTION AB view of the monitor base 605 shows the USB-C or other similar type port 630, connected to cable 632 that crosses through the interior of the telescopic arm 620 until the connecting ports located in the lower body shown in FIG. 5A to 5C. The USB-C port 630 provides the monitor with power, data and video signals. The USB-C port 630 is supported laterally by a USB flexible gum 634 that allows the monitor or other apparatuses to enter in different angles without breaking the USB-C port 630. This figure also shows the monitor unlocking button 612, that, when it is pressed, moves the opening mechanism 610 from engaged position 613 to disengaged position 615, then, the pin 614 is moved to engage or release the arm from the lower body of this invention. The unlocking button 612 also releases the monitor lock pin 616 that holds the monitor when it's installed. The opening mechanism 610 has a spring 618 that returns it to the initial position after being pressed.

FIGS. 12A, 12B, and 12C show the lateral offset angle with adjustment 662 of about 15 degrees towards each side (right 656, center 654 and left 652) that allows the articulation 655 between the telescopic arm 650 and the monitor base 660, as by a pivot joint. This allows the monitor to be moved to different angles for better visibility by rotating the monitor base 660 up to 15 degrees each side from the center line of the telescopic arm 650.

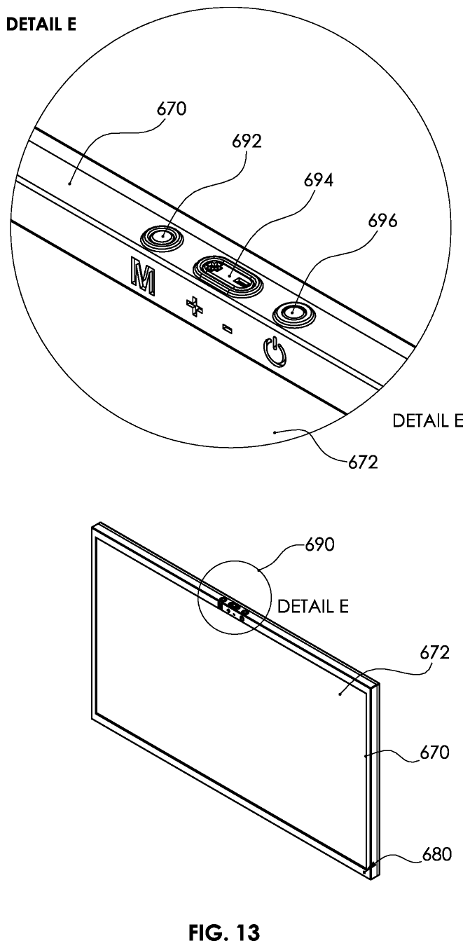

With FIG. 13, this figure shows an isometric front view of the monitor 670 with a touch-screen display 672, which has an indicator light 680 that shows when it is on, and a section of monitor control buttons 690 for monitor adjustments and settings. DETAIL E shows the monitor on/off button 696, the menu selection button 692 that shows the configuration menu to adjust the display options such as the brightness, contrast, color, video input, power input, etc., the plus/minus button 694 to scroll through the menu and select the option with the selection button 692. The speaker is designed to be in the control module. The monitors can be built with or without battery and would be of different sizes such as 8 inches or up to 25 inches.

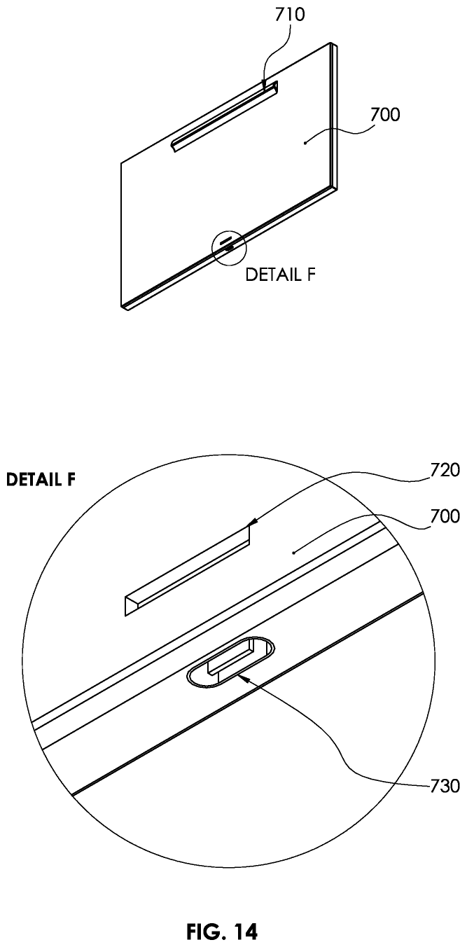

FIG. 14 is an isometric underneath rear view of the touch-screen monitor 700. In the back side of the monitor, there is a handle 710 that facilitates its manipulation. DETAIL F shows the USB-C monitor port 730 which receives the power, data and video signals, and this detail also shows the slot 720 that secures the monitor to the monitor lock pin 616 shown in FIG. 11.

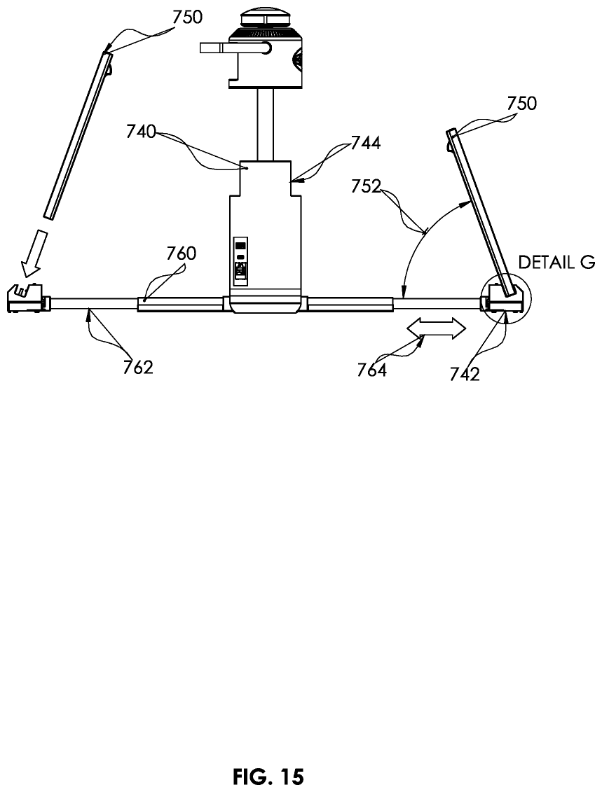

FIG. 15 shows a side view of the lower body 740 of this invention. The touch-screen monitor 750 or other apparatuses with same type of connecting port can be installed on the monitor base 742. The monitor adopts an angle of 65 degrees 752 respect to the horizontal after installed to adjust to the user's vision and it is possible zoom in or zoom out due to the displacement of the telescopic arm 762 inside the folding arm 760 of approximately 4 inches in length 764. The monitor base 742 is received into opening 744 when folded up.

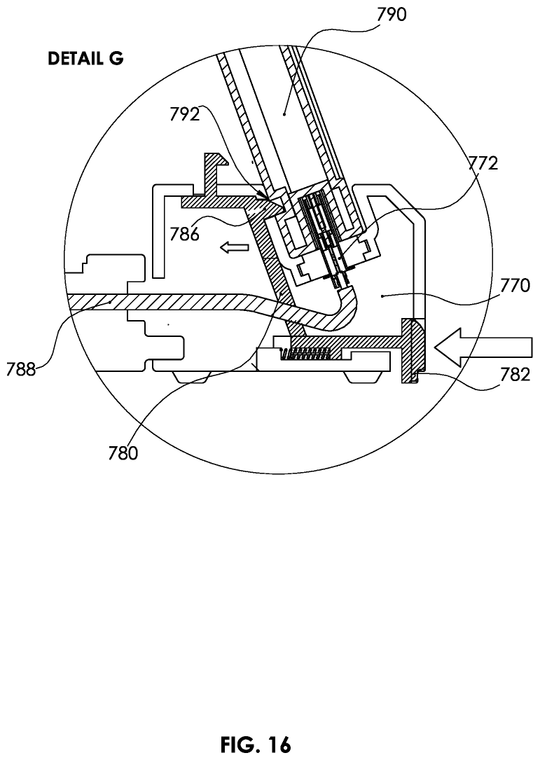

FIG. 16 shows the DETAIL G view of the monitor base 770 of this invention, where the touch-screen monitor 790 is installed. The connection is made, but not limited to, a USB-C port 772 for data, power and video transferred by cable 788 that is wired to input ports (370 of FIG. 5A) of this invention located in the lower body section (330 of FIG. 5A). The monitor 790 is secured to the monitor base 770 by a locking pin 786 that enters into the monitor slot 792 when it is pushed into port. To disconnect the monitor, it is necessary to push the unlocking button 782 in order for the locking mechanism 780 to displace the monitor locking pin 786 and release monitor 790 from this invention.

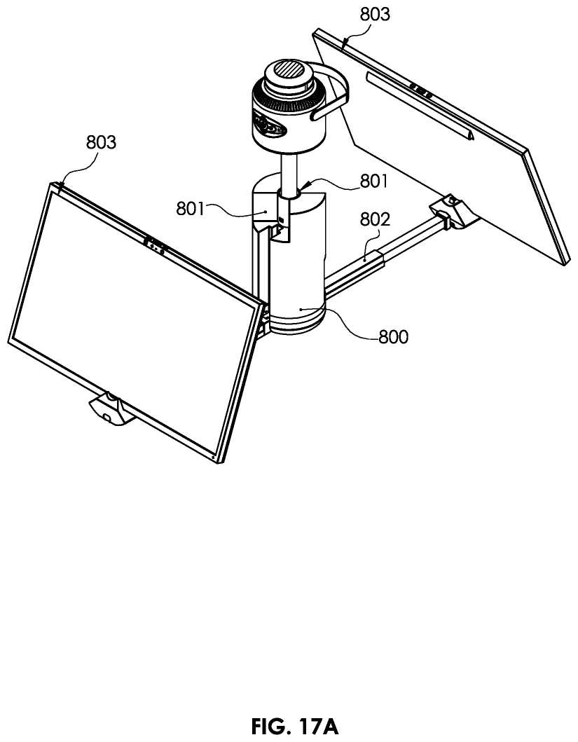

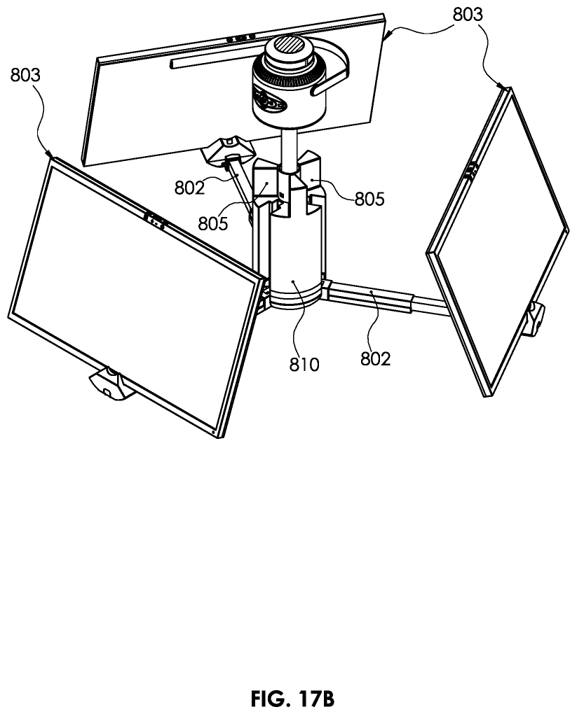

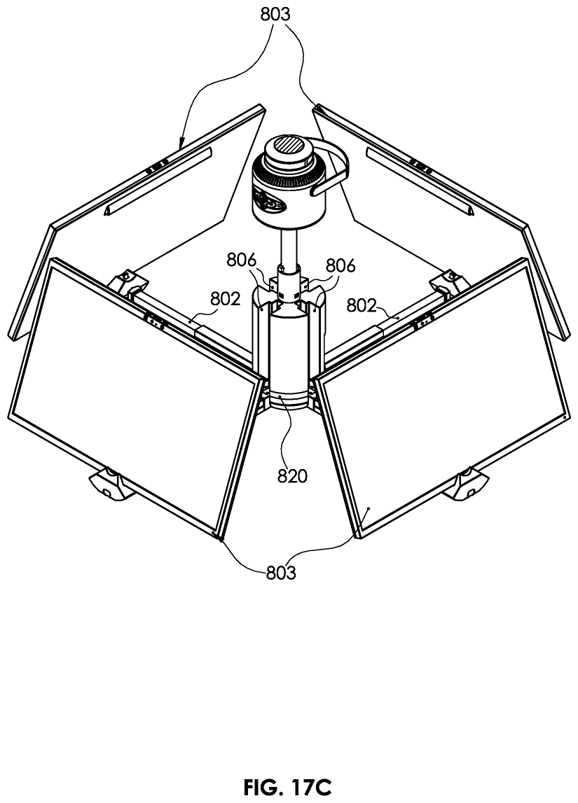

FIGS. 17A, 17B, and 17C show some of the configurations of this invention. It is possible to install two monitors 803 (FIG. 17A) with one embodiment of the lower body section (800) which has openings 801 to receive two folding arms 802, three monitors 803 (FIG. 17B) in an embodiment of the lower body section (810) which has openings 805 to receive three folding arms 802, or four monitors 803 (FIG. 17C) in an embodiment of the lower body section (820) which has openings 806 to receive four folding arms 802. Other apparatuses that have the same type of connecting port may also be installed. As previously mentioned in FIG. 6, the monitors 803 would be installed on independent bases and connected wired or wireless with this invention in order to reach farther places.

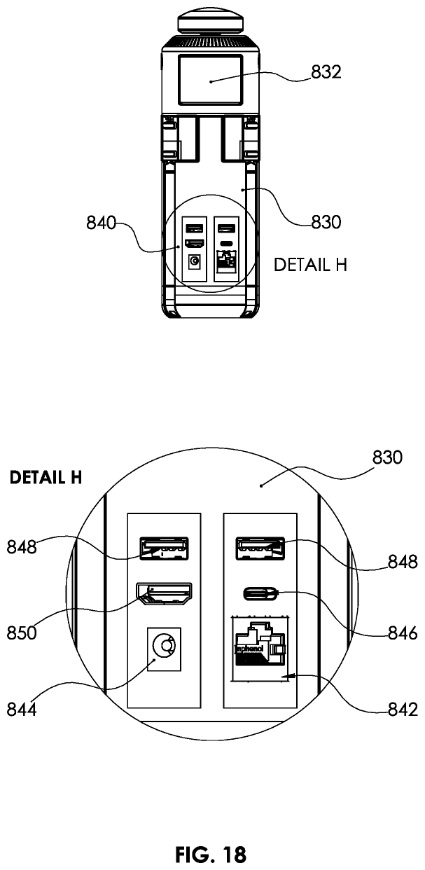

FIG. 18 shows the connection ports area 840 located in the lower body 830 of this invention, and the preview monitor 832 of about 3.5 inches that allows to see the images of the camera lens for either photographic capture or video recording. The DETAIL H shows this invention has, but not limited to, 2 USB-2.0 ports 848, an HDMI input port 850, a USB-C input port 846, an ethernet connection port 842 and a DC port 844 for the power supply.

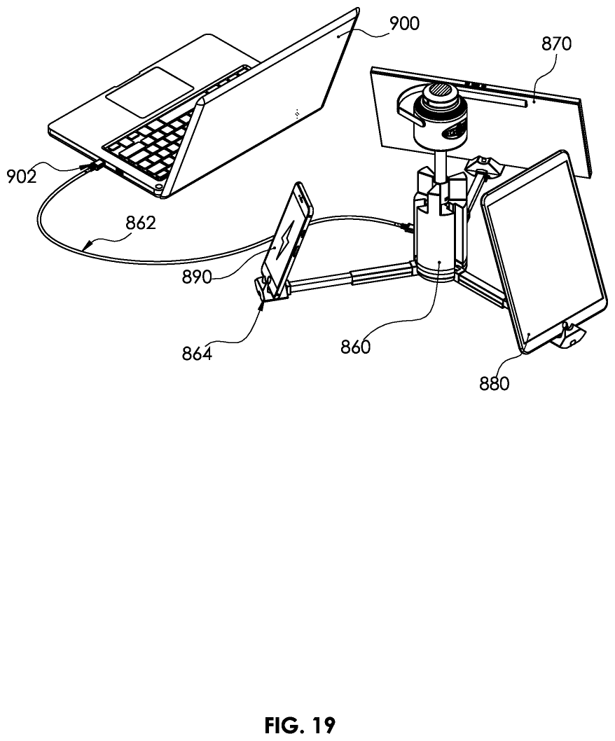

FIG. 19 shows that the connecting ports of the lower body 860 of this invention can be connected, for instance, to the USB-C port 902 of a computer or laptop 900 by means of a cable 862 in order to use the all the peripherals included in this invention such as, but not limited to, a microphone, camera, speaker, and a monitor 870 as secondary peripherals of the computer or laptop 900 or any other apparatus. Additionally, in each monitor base 864 it is possible to connect other types of devices such as smartphones 890, tablets 880 and others compatible ports to share data and recharge energy.

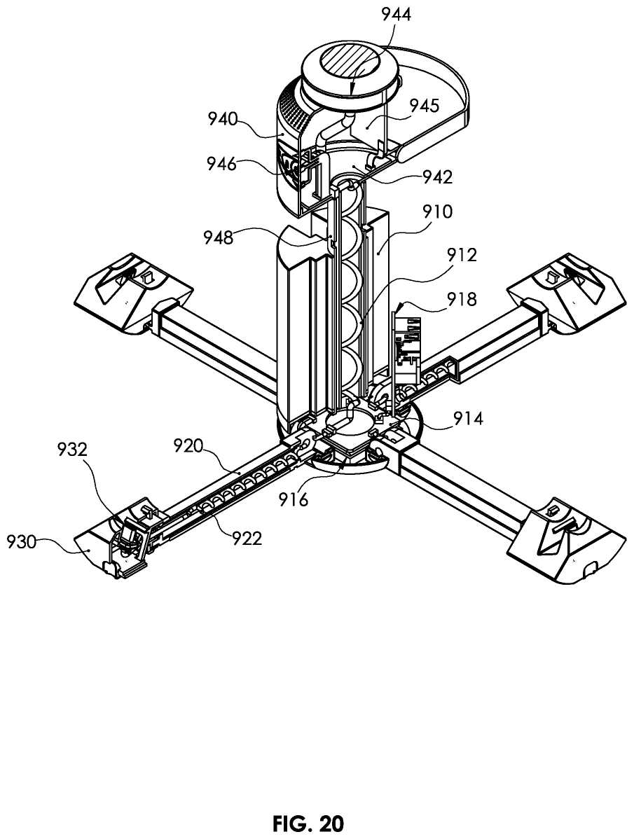

FIG. 20 shows the wiring and electronic board distribution in an isometric section view of this invention and lower body 910. In each monitor base 930 there is an USB-C connection port 932 that is connected by a rolled and flexible cable 922 located along the inside of the arms 920 to connect to the lower body PCB 914 where the rechargeable battery 916 and the PCBs of the input ports 918 are connected. Another rolled and flexible cable 912 runs through the central guide 948 of the lower body 910 connecting the lower body PCB 914 with the control module PCB 942 located in the control module 940 to connect the multimedia peripherals 944, the camera preview monitor 945 and the control buttons 946.

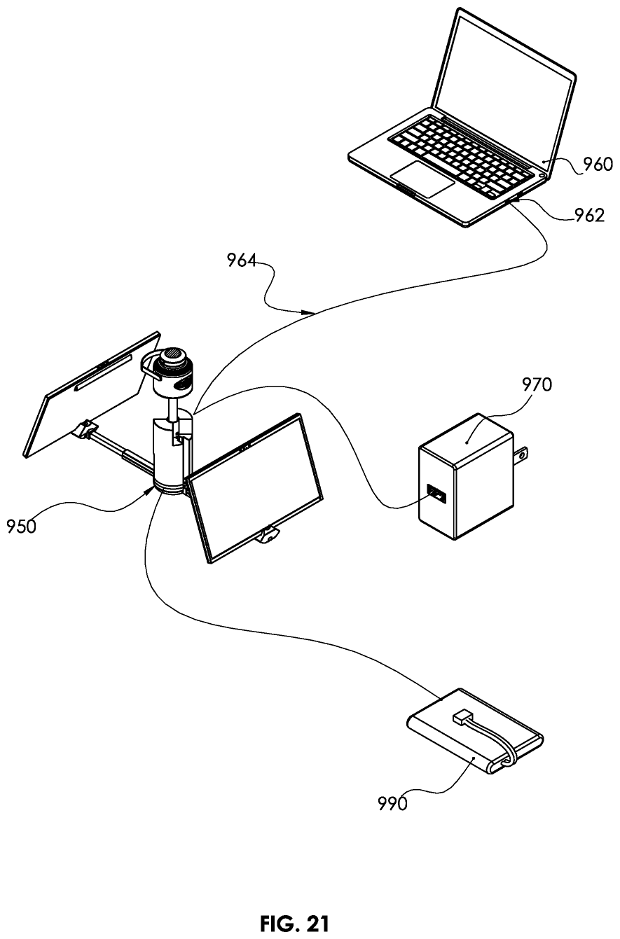

FIG. 21 shows some options to provide power supply to this invention 950. It is possible to provide power from a computer or laptop 960 by connecting a cable 964 to the USB port 962 of the computer 960. Or from an AC power adapter 970 or using a built-in rechargeable battery 990.

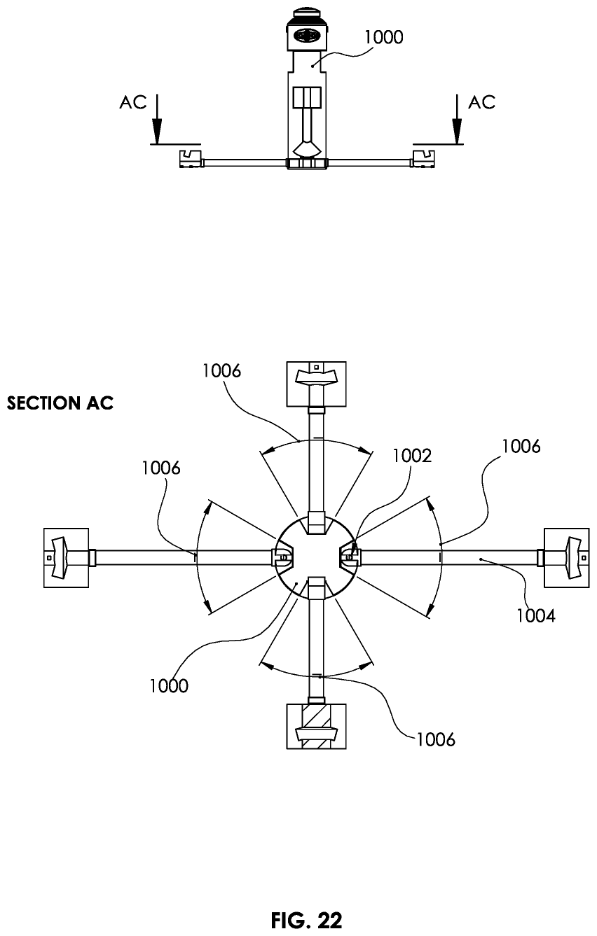

In FIG. 22, there is shown SECTION AC of the invention lower body 1000. The folding arms 1004 are attached to the lower body 1000 with a mechanical rotative joint 1002 that allows the arms to move laterally up to 30 degrees to each side, for a total rotation of 60 degrees 1006 for each arm body. This allows the bases to receive and adjust the position of the devices in different directions as desired.

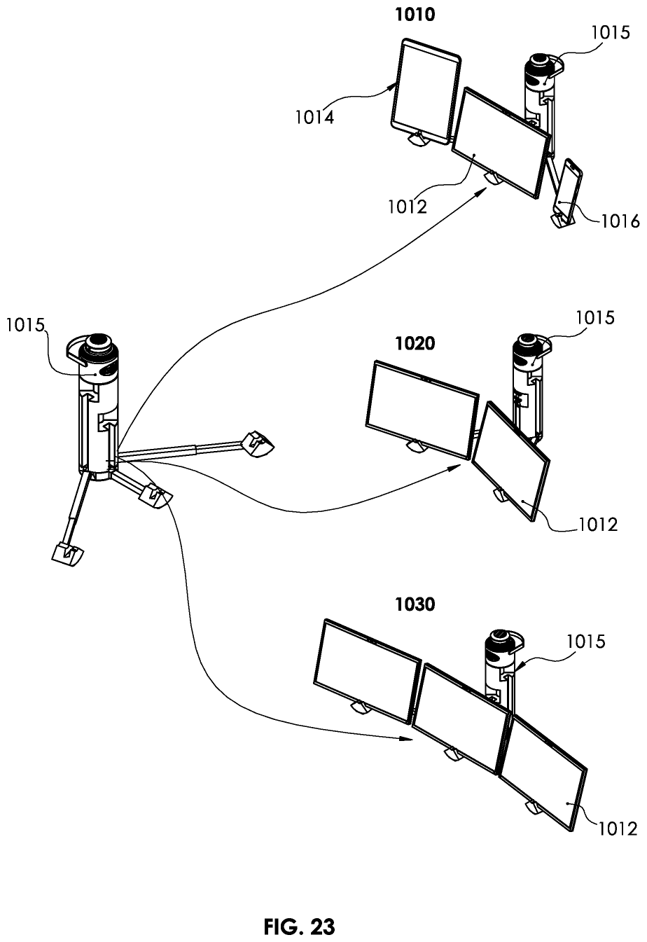

FIG. 23 This figure shows this invention 1015 with the monitors placed towards the front, forming a workstation. In the first configuration 1010 it is possible to connect a touch-screen monitor 1012 in the middle and a smartphone 1016 and a tablet 1014 on the sides and simultaneously. In the second configuration 1020, 2 touch-screen monitors 1012 are connected to this invention to act as extended monitors of a computer or laptop. And in the third configuration 1030, three touch-screen monitors 1012 with extended monitor functionalities are connected. This invention would include configurations of more than four connected built-in arms, with lower rotation capabilities.

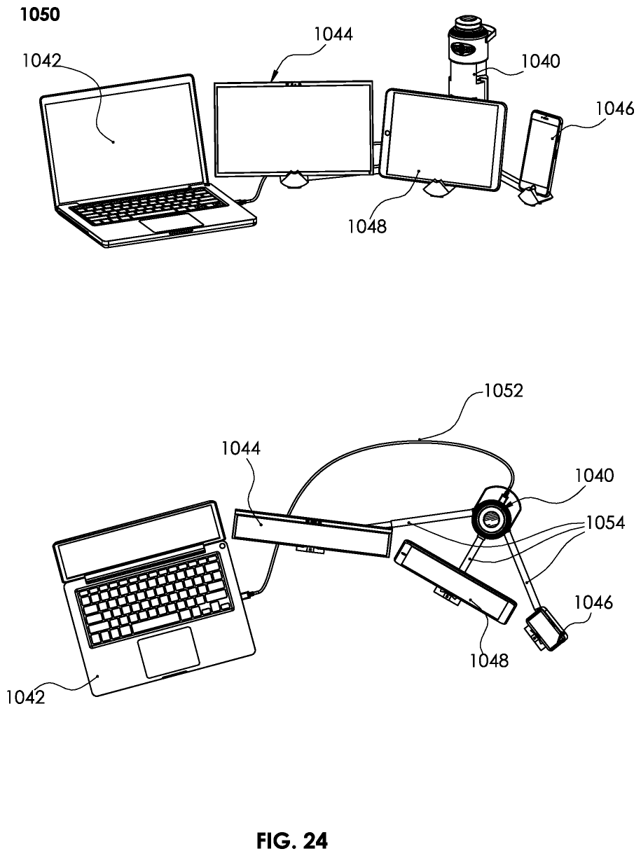

FIG. 24 shows alternative configurations of the invention, including the option 1050 which shows this invention 1040 with three arms 1054 deployed and arranged in the form of a workstation, with a personal computer or laptop 1042 in the left side, and a touch-screen monitor 1044, a tablet 1048 and a smartphone 1046 well organized and continuously charged at the right side. This invention is connected by an USB cable 1052 to the computer or laptop 1042.

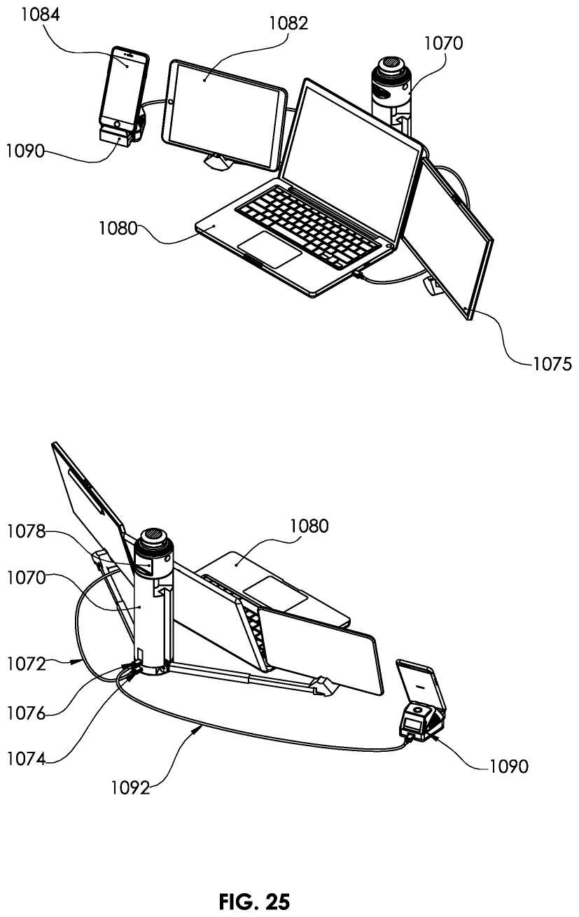

FIG. 25 shows a configuration of this invention forming a workstation where the computer or laptop 1080 is located in the center. This invention 1070 connects via USB cable 1072 to a laptop 1080 located at the front of the system. On the right side of the laptop there is a touch-screen monitor 1075 for use as an extended monitor and on the left side there is a tablet 1082 that is permanently charged and connected with the computer to transfer data and/or video by means of a compatible software. An auxiliary hub 1090 would be connected to the invention by means of a cable 1092 to a USB2 of this invention for power charging and data transmission, with a phone 1084 shown in the auxiliary hub 1090. The preview screen 1078 is shown on the back of the invention 1070, with cable USB ports 1074 and 1076 shown as well.

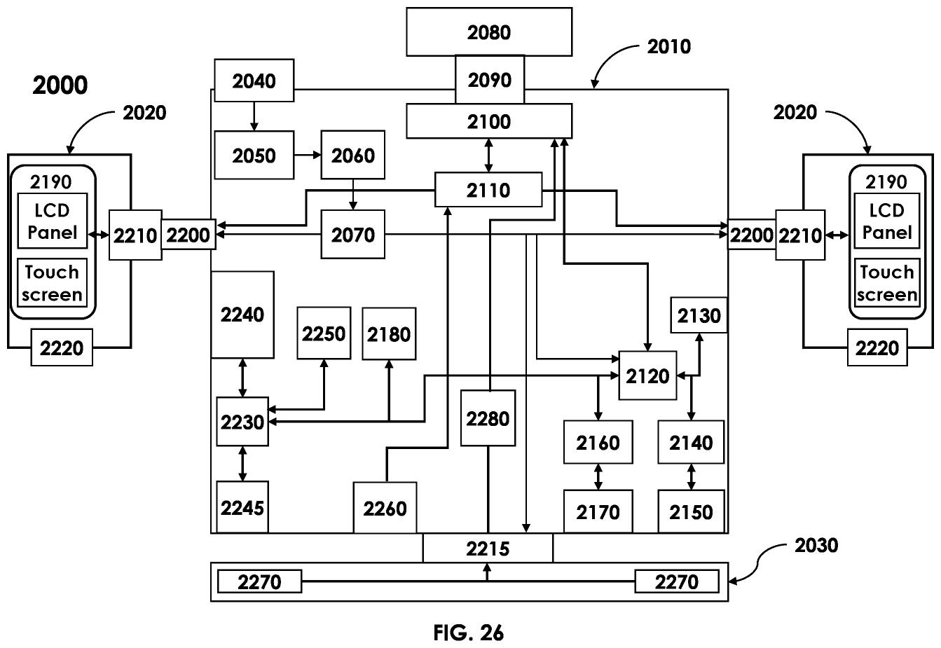

FIG. 26 describes one of the options of an electronic block diagram of this invention. This option of block diagram 2000 consists of three separate mechanical apparatus with electromechanical interconnects to the Base 2010. This invention supports (2) two or more connected monitor bases or HUBs 2020 fixed on articulating and telescoping arms 2200 connected to the lower body 2010 and a control module 2030 connected via a telescoping shaft 2215 on top of the lower body 2010. The lower body 2010 draws power from a DC input jack 2040 to power a charger module 2050 for charging an integrated rechargeable battery 2060. A power module 2070 regulates and powers devices and integrated circuits in the lower body 2010 and connected to the telescopic arms 2200 and the control module 2030. The integrated rechargeable battery 2060 provides auxiliary power when wall power is not available. A user's laptop 2080 connects to the lower body 2010 through a USB Type-C connector 2090. ESD/EMI circuitry 2100 protects and conditions the Super Speed USB signals prior to reaching a multimonitor integrated circuit 2110, and the High-Speed USB signals prior to reaching an integrated USB HUB 2120. The USB HUB 2120 provides data connection to one or more USB Type-A connectors 2130, a USB Audio Codec 2140 and Microphone 2150, a USB Audio Amplifier 2160 and Speaker 2170, and an embedded flash drive 2180. In one embodiment the Microphone 2150 and Speaker 2170 are contained within the control module 2030. The multimonitor integrated circuit 2110 allows the connected laptop 2080 video connection to one or more monitors 2190 with touch-screen monitor capability, connected on the telescoping arms 2200 through a USB Type-C connector 2210. In various embodiments the monitor interfaces supported may include but is not limited to Display Port, HDMI, Thunderbolt and VGA. Monitor 2190 power is provided by the power module 2070 through the USB Type-C connector 2210. Each remote HUB 2020 provides a USB Type-C connector 2220 and provides power for charging connected devices. An HDMI connector 2260 is also provided for user devices that lack support for USB Type-C, and still wish to make use of the multi monitor capability. In one embodiment, the lower body 2010 contains a Microcontroller Unit (MCU) 2230 powered from the Power Module 2070. The MCU 2230 handles inputs from a User Interface panel 2240. Supported features include a battery gauge, volume control, camera control, audio control, power on/off, Bluetooth pairing, WiFi commissioning and other configuration processes. In one embodiment these buttons and LEDs may be split up into multiple interface panels. These inputs may be processed locally and used within the Lower body 2010 or provided back to the connected laptop 2080 for remote handling. The MCU 2230 connects to the USB Hub 2120 and therefore has access to the same connected capabilities such as data connection to one or more USB Type-A connectors 2130, a USB Audio Codec 2140 and Microphone 2150, a USB Audio Amplifier 2160 and Speaker 2170, and an embedded flash drive 2180. In one embodiment voice recognition would be available in the MCU and accessed via the Microphone 2150. An RJ45 jack 2245 for ethernet is provided on the lower body 2010 and allows the MCU 2230 to perform as a WiFi access point or repeater via a WiFi module 2250. Bluetooth 5.0 is also supported for easy commissioning and configuration of the device 2000, and remote pairing of 3rd party Bluetooth accessories. The control module 2030 contains one or more cameras 2270 that utilize a MIPI interface through the telescoping shaft 2215 to a MIPI to SS conversion IC 2280. This allows the user's connected laptop 2080 access to the camera video streams. Each embodiment may make use of a different number and location of cameras, and cameras with varying resolutions and fields of view.

### Usage

The present invention is the new generation of the portable monitor and hub system that incorporates the flexibility to transport, install and interchange different types of apparatuses combining with IoT capabilities, such as secondary monitors, video-cameras, microphone, speakers, all-in-one portable hub system for presentations, teamwork and to boost users work performance. The following are some of the uses of this invention:

Companies whose employees have a busy agenda of meetings on a daily basis. Sometimes companies have their meeting rooms completely booked in advance, leaving unscheduled meetings out of proper videoconferencing equipment. Employees usually have to move around different places and improvise videoconferencing equipment, to be able to attend clients and other important matters.

Professionals from various areas who work on a computer on a daily basis, that need to work remotely and find difficulties at multitasking or quickly setting up computer peripherals. They usually need a wide visibility of the tasks they are executing on the computer and other devices, but it is generally difficult to have everything at a glance and in an organized way.

Students who need to carry out various tasks at the same time, while doing homework or receiving an online lesson. They usually access media content on their phones while working and they seek to be connected in every way possible. They usually find themselves trying to make the most of their devices by using them for different purposes at the same time, which makes it difficult for them to organize their desk in a comfortable way.

Social Entertaining: Those who enjoy having house parties that usually take place in the kitchen and other spaces around the house such as the living room or the pool. They usually use devices to play music and take pictures and video to document their experiences and share them in social media platforms. They usually find it difficult to move the party environment around the house as their devices work separately.

### Description of Production

The multiple pieces of the outer shell of the hub are made of acrylonitrile butadiene styrene (ABS) plastic that has been injection moulded. Sections of the outer shell may also have an additional material such as thermoplastic polyurethane (TPU) or silicone. The power, data and video transfer options would be done by using USB type C, USB2.0, HDMI among other available wired and wireless technologies. All buttons, switches, electrical micro-switches (made of plastic and metal) are also commodity components that have been manufactured and/or sourced from other suppliers. Integrated circuits, chipsets and printed circuit boards (PCB) are also standard items, although different proposed functions of the hub may have proprietary chipsets designed, printed and programmed to fit the requirements of each peripheral function that is to be added to the hub.

The printed circuit board (PCB) on which the electrical and mechanical components are mounted is custom-made for the functional design of the hub peripherals. It is a flat, resin-coated sheet. Electrical resistors, capacitors, oscillators, integrated circuits (ICs), and other components are made of various types of metal, plastic, and silicon, also sourced from manufacturers that produce in mass.

The general shape of the PCB falls within the range of a top-end industrial design product that is available in the current market but may be produced slightly larger to accommodate for the added internal components that are built into the hub. The overall layout is similar as well, its orientation is symmetrical along a line that runs from the front to the back of the body of the hub along the top face. The hub has been detailed designed to obtain the smallest and carry-on size to allow for the addition of the proposed peripherals. On this hub, there are holes moulded in the shell to allow for sounds to leave the device via internally mounted drivers. On the front there are activation buttons to accommodate the functions of the added devices that become mounted into the hub.

The invention is not restricted to the details of the foregoing embodiments. The invention extends to any novel one, or any novel combination, of the features disclosed in this specification (including any accompanying claims, abstract and drawings), or to any novel one, or any novel combination, of the steps of any method or process so disclosed.

What is claimed is:

1. A portable system comprising:
a central cylindrical control module having a central axis and a lower body portion; said cylindrical control module having at least one telescopic arm which is contained within said central cylindrical control module in a first locked position in said lower body portion and in a second unlocked position, said at least one telescopic arm capable of extending and rotating vertically and horizontally to a selected location;
said at least one telescopic arm receiving a periphery device in a receiving slot at an end of said at least one telescopic arm to electrically connect said periphery device to said central cylindrical control module.

2. The portable system of claim 1 further comprising a monitor base connected at said end of said at least one telescopic arm.

3. The portable system of claim 2 wherein said monitor base has a locking pin for locking said at least one telescopic arm in said first locked position.

4. The portable system of claim 1 wherein said central control module is extendable in a telescopic manner along said central axis.

5. The portable system of claim 1 wherein said central control module includes multimedia peripherals.

6. The portable system of claim 2 where said monitor base rotates 15 degrees laterally from a center line of said at least one telescopic arm to allow articulation between said at least one telescopic arm and said monitor base.

7. The portable system of claim 1 wherein said at least one telescopic arm includes up to four telescopic arms.

8. The portable system of claim 1 wherein said at least one telescopic arm includes three telescopic arms.

9. The portable system of claim 1 wherein said at least one telescopic arm includes two telescopic arms.

10. The portable system of claim 2 wherein said monitor base receives a cable from said at least one telescopic arm, said cable connects to a port located on said lower body portion of said central cylindrical control module.

11. The portable system of claim 2 wherein said monitor base has an opening mechanism which moves from an engaged position to a disengaged position.
